(19) United States
(12) Patent Application Publication
(10) Pub. No.: US 2002/0041238 A1
(43) Pub. Date: Apr. 11, 2002

(54) Pager based monitoring

(76) Inventors: Roderick Michael Johnson, Calgary (CA); Douglas R. Hamilton, Calgary (CA)

Correspondence Address: BENNETT JONES LLP, 4500 Bankers Hall East, 855-2nd Street SW, Calgary, AB, T2P 4K7, CA

(21) Appl. No.: 09/918,518

(22) Filed: Aug. 1, 2001

Related U.S. Application Data
(63) Continuation of application No. 09/054,035, filed on Apr. 2, 1998.
(60) Provisional application No. 60/069,326, filed on Apr. 1, 1997.

(51) Int. Cl. H04Q 1/30

(52) U.S. Cl. 340/870.28; 340/7.21

(57) ABSTRACT

A remote monitoring system uses a bi-directional pager communications system for monitoring remote monitoring stations. Each remote station includes monitoring hardware, data storage for recording data collected by the monitor and a pager for transmitting the data to a user through a commercial pager system. The pager also receives control signals from the user. The remote station may include control devices for altering the monitoring process or varying other operating parameters. As a data communications system, the bi-directional pager or digital cellular PCS modem can be mated to most any monitoring device. This allows for inexpensive monitoring because the need for frequent visits to the remote site is eliminated. Where a monitored site is not within an area covered by a host pager service, a mobile pager host is used as an intermediary for collecting monitoring data and delivering control data.

This is a continuation of application Ser. No. 09/054,035, filed Apr. 12, 1998, which is hereby incorporated in its entirety by reference.

### FIELD OF THE INVENTION

The present invention relates to remote monitoring.

### BACKGROUND OF THE INVENTION

Remote monitoring systems have been used for various purposes. They are often used where continuous monitoring or frequent polling is required. They may also be used where the cost of manual data retrieval exceeds the cost of installing, operating and servicing the monitoring system.

Significant limitations on the viable installation of remote monitoring systems include the costs of hardware, power supply and communication.

Hardware costs include the capital cost of hardware, including user interfaces. These costs can in some cases be reduced with volume production. Reduction of hardware costs remains an important objective.

The costs of supplying power include the capital cost of the system used, including installation costs, and operating costs. With a system that monitors remote sites, it is not always practical to incur the capital cost of installing power transmission lines. The actual cost of power consumed may be a problem where a commercial power source is used. Battery powered systems may be used in some instances, but battery life and reliability are severe limitations on of such systems.

Communication costs include the capital and operating costs of the communication system for delivering data from the remote monitoring sites to the user's base site. Where fixed land lines are used, installation and maintenance costs may be a significant factor. For third party telephone lines or the like, the service charges, including long distance fees, may be significant. For radio links, the hardware cost of a transceiver at each site, the requirement for communications authority approvals and transmission reliability are all concerns that must be addressed. Using a commercially available system such as a cellular telephone system or a satellite link is generally prohibitively expensive, although they are used in some instances. These systems become a substantial part of the overall system cost.

One of the more difficult problems to overcome when considering a remote system is the high cost of installation, not only of an electrical supply, but also telephone lines, radio antennas or some other medium, for external data transfer. Field personnel capable of installing these items are costly, whether contracted or in-house personnel. Ensuring costs are kept low is difficult if highly skilled installers are required, especially where large numbers of installations are required.

In consequence, there are monitored systems where manual readings are performed on a periodic basis. One example is monitoring the cathodic protection of pipelines and other metal structures. Manual readings are taken at test points installed at the monitored site. In the case of a pipeline, test points will be distributed along the line and must be visited any time a reading is to be taken.

The present invention is concerned with a system that can be employed at reasonable cost to provide effective monitoring in many such applications.

### SUMMARY OF THE INVENTION

According to the present invention there is provided a system for monitoring the values of selected parameters at a plurality of remote sites, the system comprising:

a bi-directional wireless digital data communications system for receiving and transmitting coded signals from and to a plurality of transceiver units;

a plurality of remote stations, each including:

monitoring means for determining the values of said parameters;

encoding means for encoding the values determined by the monitoring means;

recording means for recording data representing the encoded values;

receiver means for receiving control signals from the pager system;

transmitter means for transmitting recorded data to the pager system; and

actuation means responsive to receipt by the transceiver of a control signal for actuating the transmitter means;

a user station including:

means for transmitting control signals to the pager system for onward transmission to the respective remote stations; and

means for receiving data from the pager system.

As a data communications system, the bi-directional pager or digital cellular PCS modem can be mated to most any monitoring device. This allows for much cheaper monitoring because the need for frequent visits to the remote site is essentially eliminated. The same unit can be linked to another device that can effect changes in, for example, the settings of various pieces of equipment. This provides the ability to both monitor and actively control a remote site at a much smaller cost than other data transfer systems.

The bi-directional pager is capable of both receiving messages from and transmitting messages to a host paging system. These pagers can function in any area where a host pager system is available. Through the host system, the pagers can initiate the bi-directional transfer of data to another pager or to another communication system, for example the Internet, a telephone system, radio, etc.

The present system may also be used where a host system is not available through the use of a mobile host system that may be transported by an appropriate vehicle (land, water or air craft) into the coverage area of the remote monitor/control system.

Existing bi-directional pager systems are configured to transmit and receive text messages encoded using the ASCII character set. It is therefore necessary, in order to use a pager system, to encode and decode the data using the ASCII code.

It is an advantage of pager systems that they have marked high and low usage periods, with the high periods usually occurring during normal business hours. Consequently, the transmission of data can be done at off peak hours when the system is under utilized. This can bring the service costs down to a level where remote monitoring is a practical option for many monitoring and control applications.

The remote station will normally be programmed to automatically assume a sleep mode. Only the receiver and a clock remain active. This conserves power so that a battery, solar power system or a combination of the two can provide adequate power for an indefinite period.

For illustrative purposes, the invention will be described in terms of the use of a bi-directional pager as the communication system. It is to be understood, however, that other technologies, especially the digital PCS modem are also useful according to the invention.

### BRIEF DESCRIPTION OF THE DRAWINGS

In the accompanying drawings, which illustrate one embodiment of the present invention:

FIG. 1 is a schematic block diagram of a system according to the present invention;

FIG. 2 is a schematic block diagram of a remote monitor and controller;

FIG. 3 is a schematic diagram of a mobile host pager system; and

FIG. 4 is a block diagram of a system for use in monitoring cathodic protection on a pipeline.

### DETAILED DESCRIPTION

The System

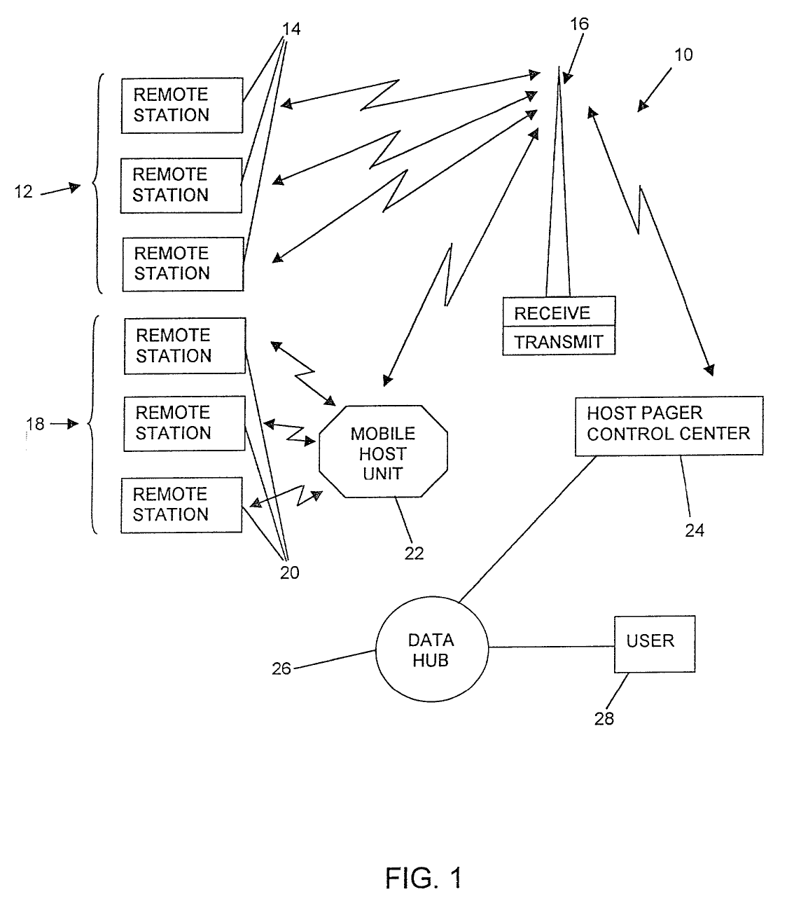

Referring to the accompanying drawings, FIG. 1 illustrates a system according to the present invention. The system 10 includes a set 12 of three remote monitoring and control stations 14 that are located within the coverage area of a host pager system transmitter/receiver 16 with which they communicate. The system also includes a second set 18 of three remote monitoring and control stations 20 that are outside the coverage area of the host system transmitter/receiver 16. The stations 20 communicate with a mobile host pager system 22 that is portable to travel into range of the stations 20 and the host system transmitter/receiver 16. The transmitter/receiver 16 communicates with a host pager control center 24 which directs data communications amongst the transmitter/receiver 16, a data hub 26 and a user's communication system 28.

Remote Monitor and Control Station

The remote monitor and control stations 14 and 20 are flexible stations that can be used for most applications that require remote monitoring or control. A station includes a pager 30, which is a bi-directional pager unit including a receiver 32 and a transmitter 34 to receive data from and transmit data to the host pager system transmitter 16. The pager also has an input/output for communicating with a controller 38 for controlling the functioning of the station. A pager of this type is available as the Motorola REFLEX™ Associate PCS Modem.

The station 14 or 18 includes a monitor 40 for measuring the monitored parameters, including the dynamic properties of processes being performed, e.g. flow through a pipe and variable properties of the environment, e.g. temperature.

The station also includes an effector 42 which is used to effect changes in the monitoring and controlling properties of the station. The effector is a device or system for altering the present state of the station's environment through the use of, for example, motors, valves, power supplies etc.

The controller 38 includes a processor 44 and control circuitry 46 for controlling the operation of the station elements. It also includes a memory component 48 for recording data to be transmitted to the host system through the pager 30. The processor 44 controls the monitoring and storage of data collected through the monitor 40, the transfer of data thorough he pager 30, the changing of environmental conditions through the effector 42. The processor may include control algorithms including proportional, integral and differential (PID) feedback control algorithms.

The remote station includes a power supply 50. This is an external source of power that may be, for example, land lines, a solar array, batteries, any combination of these, or any other available supply of power.

Host Pager System

The host pager system 24 is a commercial system that transfers messages, including data between the pagers 30 of the individual remote stations 14 and 20 and the end user of the system. The transmitter/receiver 16 communicates with the pagers 30 using an appropriate protocol, for example the REFLEX™ protocol. The control center 24 includes the necessary systems for directing data flow amongst the host pager transmitter/receiver 16, the hub 26 and the user's communication system 28. One example of a control center is Mtel Corporation.

User System

The user system includes the data hub 26 and the user communication system 28. The data hub includes systems for transforming data packets that are transferred between the user and the remote station into a meaningful compilation. The compilation is then passed on to the user by a communication system, e.g. the Internet and to the remote station by the host pager system.

The user communication system 28 includes the necessary means for the user to communicate with and control the remote stations through the host pager by way of a communications interface that may be, for example, telephone, internet, cellular telephone, or satellite communications.

Mobile Host Pager System

Under normal operating conditions, a bi-directional pager will only be able to communicate when the unit is within an area served by a host pager system. This currently precludes the use of pagers in unserviced locations. For source of power that may be, for example, land lines, a solar array, batteries, any combination of these, or any other available supply of power.

Host Pager System

The host pager system 24 is a commercial system that transfers messages, including data between the pagers 30 of the individual remote stations 14 and 20 and the end user of the system. The transmitter/receiver 16 communicates with the pagers 30 using an appropriate protocol, for example the REFLEX™ protocol. The control center 24 includes the necessary systems for directing data flow amongst the host pager transmitter/receiver 16, the hub 26 and the user's communication system 28. One example of a control center is Mtel Corporation.

User System

The user system includes the data hub 26 and the user communication system 28. The data hub includes systems for transforming data packets that are transferred between the user and the remote station into a meaningful compilation. The compilation is then passed on to the user by a communication system, e.g. the Internet and to the remote station by the host pager system.

The user communication system 28 includes the necessary means for the user to communicate with and control the remote stations through the host pager by way of a communications interface that may be, for example, telephone, internet, cellular telephone, or satellite communications.

Mobile Host Pager System

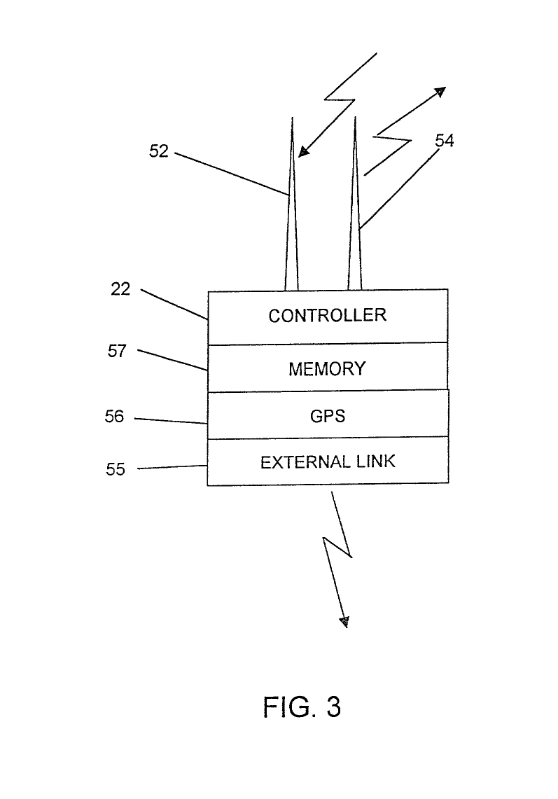

Under normal operating conditions, a bi-directional pager will only be able to communicate when the unit is within an area served by a host pager system. This currently precludes the use of pagers in unserviced locations. For present purposes a mobile host pager system may be employed to free the page of this constraint. A schematic representation of this system is given in FIG. 3.

The mobile host pager system 22 includes a receiver 52 for receive data from the remote station 20 and a transmitter 54 for transmitting data to: station 20. An external link 55 communicates with the stationary host pager system 24 to transmit data and messages between the mobile and station˜ systems. The mobile host includes a Global Positioning System (GPS) 56 monitor the global geographical position of the mobile host pager system. T mobile host system has data storage 57 for recording data received from t remote stations and from a stationary host system. To establish communication between the mobile host system and a remote station, the mobile host system transported into the range of the remote station. Any appropriate vehicle could be used for this purpose. The GPS allows the mobile host to determine i location in relation to that of remote stations to be serviced. In the absence GPS, the mobile host could query its current coverage area blindly for any remote stations within that area.

When the mobile host is within range of a remote station communication is initiated. Data may be exchanged between the two, with the mobile host storing data in memory. When the mobile host completes a sweep of an unserviced area and returns to a serviced area, it downloads collected data t the host pager system for onward transmission to the end user. It may also receive and store messages that are to be sent to the remote stations.

Data Formatting

The most common format for most monitoring systems is a standard 128 or 256 ASCII character format. This format allows the use of standard terminal emulation programs (ANSI, VTI00, etc.), and allows the data to be manipulated by the vast majority of data management programs. The characters can be sent together as strings, to send text messages. This method is not very efficient for data transmission purposes, however. In the case of data that requires a time/date verification, such as an analog reading of a voltage, there are a minimum number of characters required.

Example

| Voltage | Time | Date |
|---|---|---|
| 10.43 VDC | 10:50:39 | 03/1597 |

This makes up a total of 26 bytes. To this must be added a unique identifying address, so that we know where the data is from. In a large system where there are tens of thousands of addresses a 2 to 4 byte address would be required.

This type of data format is not required in this case, because there is no support for the use of terminal programs, nor is it desired to provide easy access to the information. This allows the creation of a form of data compression and encryption by the way the data is packaged. Specialized software receives the information transmitted by the pager system, and parses the bytes received to extract the encoded information. A good example is ten time data stamped voltage readings.

Example:

| | | |
|---|---|---|
| 10.43 VDC | 10:50:39 | 03/15/97 |
| 10.42 VDC | 10:50:40 | 03/15/97 |
| 10.47 VDC | 10:50:41 | 03/15/97 |
| 10.51 VDC | 10:50:42 | 03/15/97 |
| 10.46 VDC | 10:50:43 | 03/15/97 |
| 10.48 VDC | 10:50:44 | 03/15/97 |
| 10.50 VDC | 10:50:45 | 03/15/97 |
| 10.53 VDC | 10:50:46 | 03/15/97 |
| 10.55 VDC | 10:50:47 | 03/15/97 |
| 10.52 VDC | 10:50:48 | 03/15/97 |

Elimination of the decimals, punctuation and spaces eliminates seven bytes to look this:

| | |
|---|---|
| 1042 VDC | 105040031597 |

In a ten reading transmission, this eliminates 70 bytes of a previous 260 bytes.

This file can then be converted to a time/date stamped file which gives a start time and a time increment. Additionally, if we know that there are only certain values which we read such as voltage, current, potential, and on or off status, a vastly smaller number of bytes are required to reconstruct the same information as the above example.

If we use the initial date bytes, and then use an interval byte, which would be capable of describing 256 different time intervals, of our choosing, such as seconds, minutes, hours, etc., and an information byte which indicated VDC, or VAC, or amperage or potential, plus or minus, etc. we would end up sending a vastly shorter string.

Example:

105039031597SV1043104210471051104610481050105310551052 105040=10:50:39 or the start time

S=seconds

V=voltage DC, as a four character number with two decimal places followed by all ten readings.

Thus the original message of 10 times 26 bytes per reading plus line breaks, or 269 bytes total, can be compressed to 57 bytes, almost five to one. For larger amounts of data, such as a hundred readings, further description bytes or multiple description bytes allow even greater compression ratios.

There are other forms of compression that can be used in the transfer of data from the monitoring unit, By bit shifting the individual bytes and using character substitution, very effective encryption of the data can also be enabled.

Hardware Design

The system should be able to operate for long periods of time without intervention. Some exemplary specifications for the hardware part of the system are:

Microprocessor
Analog to Digital converters (A/D's)
Digital to Analog converters (D/A's)
Galvanic isolation on analog and digital inputs
ROM expansion capability
Analog conditioning input circuits
Analog conditioning output circuits
Built in day/date clock, calendar with interruptible alarm feature
Discrete, logical Input/Output channels for status inputs or outputs
Precision voltage reference
Serial ports with RS232 or RS485 capability
Remote diagnostic capability
EEPROM or some type of non-volatile memory
End effectors, actuators

To conserve power, the remote station will go into sleep mode, conserving power to most functions, except the day/date clock, calendar and the receive line. All other circuits will be turned on or off, under processor control. When a scan of the inputs is required, on a selected time schedule, the processor will turn on and initialize itself. Subsequently, readings will be taken, written to non-volatile memory and verified. If communication is required through the pager or some other means, it will be turned on, and allowed to initialize. Data transfer will take place, and the system will turn itself off again.

Of the A/D's, a number are reserved for internal diagnostic functions. These provide battery voltage, verification of analog circuit operations, etc. Of the inputs/outputs, a number are reserved for memory problems, processor malfunctions, etc. In the case of a system malfunction, a status byte is built that clearly indicates the subsystem malfunction. In a 256 character ASCII protocol, eight statuses would be verified through a single character, that upon conversion by the host software, would be extracted as follows:

Example

11111111, for all systems operational

1111101111, 0 for system 4 malfunction

In this way we verify proper operation without burdening the system with a lot of data transmission overhead. In circumstances where manual intervention is required, such as a technician inspecting the system, a serial connection via a laptop computer will awaken the system, and hand over control to the operator. The unit will time out upon disconnection from the serial connection.

The serial ports, are implemented by using a four channel UART chip. The serial ports maintain a great deal of system flexibility. Port one is reserved for remote transmission via pager or other means. Port two is reserved for laptop connection. Port three is reserved for external serial RS232 or RS485 devices, such as a GPS card or specialized sensors. Port 4 is reserved for a RS485 serial connection where multiple monitoring points can be tied in to one Pager to Transmission device. This allows multiple monitoring units to be paralleled to provide data from up to 124 analog channels and 124 discrete channels.

Application to Cathodic Protection of Pipelines

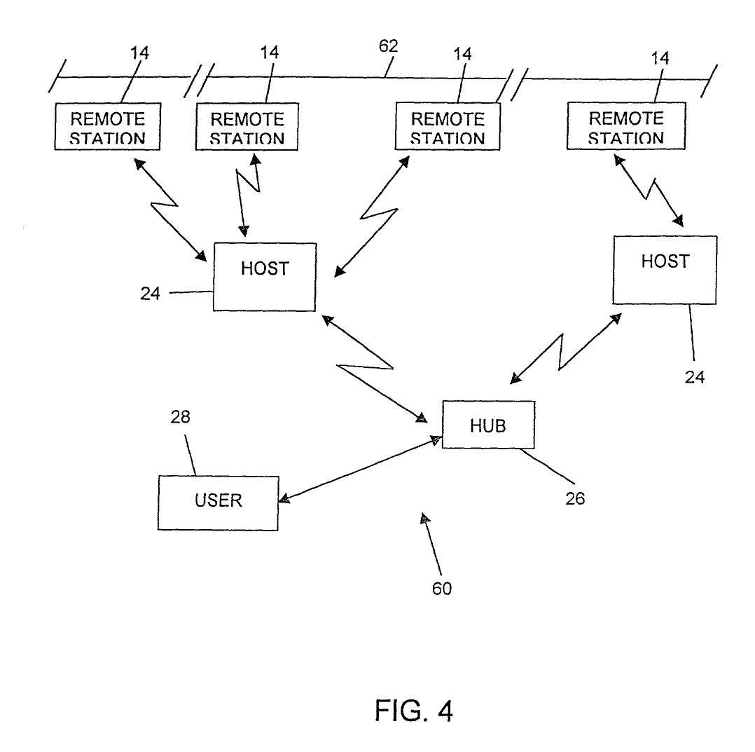

An application of the system to monitoring the impressed current cathodic protection of pipelines is illustrated in FIG. 4. In that drawing a system 60 according to the present invention applied to monitoring the cathodic protection of a pipeline 62 hundreds of kilometers long and requiring cathodic protection every 10 kilometers. For proper maintenance, remote monitoring stations 14 are spaced along the pipeline at least every 10 kilometers and coupled to it to measure the corrosion protection parameters of the pipeline. These include the voltage of the pipeline relative to ground and current passing into the pipeline.

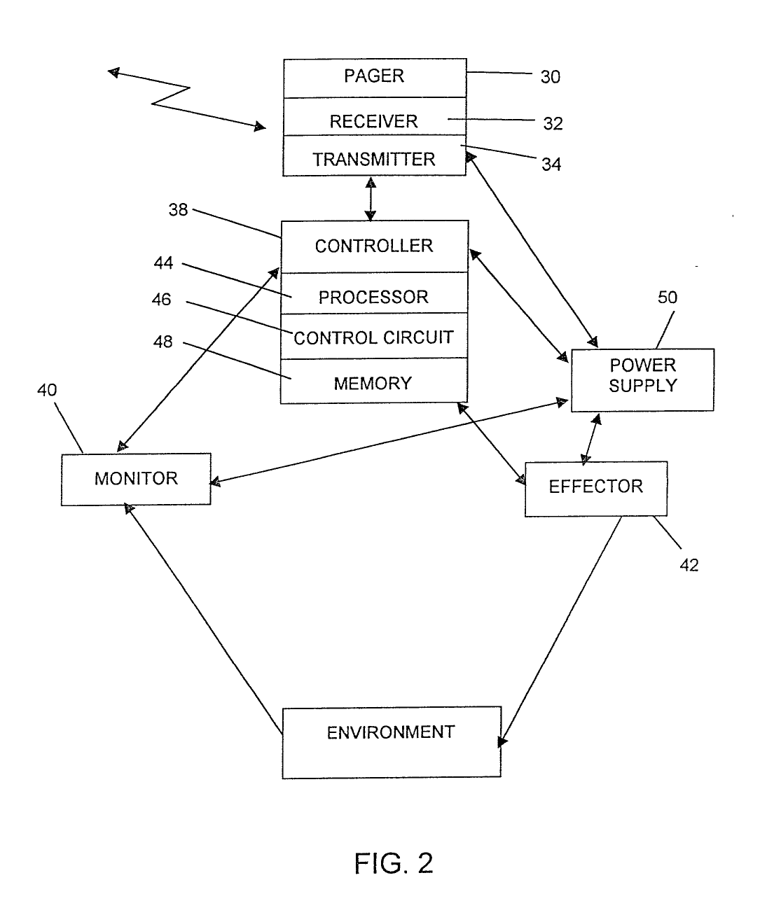

Each remote station also includes an effector (FIG. 2) for altering the function of the cathodic protection devices applied to the pipeline. With a corrosion protection power supply, the effector controls the setpoints of the power supply. The setpoints may be altered autonomously by the remote station based on the measurements taken by the monitor. They may also or alternatively be altered according to algorithms received from the user through the pager.

Referring to FIG. 2, in each remote monitoring station 14 the monitor 40 is connected to the pipeline to measure the pipeline voltage and current. This indicates the state of the cathodic protection. This is an analog signal that is processed by the processor 44 to provide a digital signal that is stored in memory 48 for communication to the host site 24 through the pager 30. The power source 50 includes a solar panel and a battery to provide power to the system.

With a system the size of that shown in FIG. 4, the remote stations will communicate with multiple host control centers 24. The hosts in turn communicate with the data hub 26.

Other Applications

The system described herein has many applications in addition to the corrosion protection monitoring application discussed above. Some of these additional applications are discussed in the following, without limiting other applications.

Medical

The invention is applicable to the monitoring of medical patients and reporting to a health care worker as the user. The patient's condition may be monitored, and medications administered automatically or under the control of the health care worker.

The remote, patient monitoring unit may be used to inform the patient, the health care worker or both of an emergency or urgent situation.

Specific medical applications are blood glucose monitoring, blood pressure monitoring, blood chemistry monitoring (International Normalization Ratio), heart rate monitoring and medication scheduling.

Environmental

The system may be used for a number of environmental monitoring tasks These include monitoring emissions, for example from smoke stacks and reporting of weather conditions.

Crime Prevention

The system is useful in electronic shackling to monitor those fitted with the device.

In remote locations, the system may be used in an alarm system.

Other

The system is useful for inventory control in certain industries, for example automobile rental where fuel quantity, engine health and mileage may all be monitored. If the remote unit is mated to a GPS, vehicle location may also be monitored.

When used with a GPS monitor, the system has a number of uses, including monitoring children, wild animals and packages during delivery.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A system for monitoring at a plurality of remote sites the values of selected parameters, the system for use with a wireless digital communications system and a monitor/encoder for determining and encoding the values of the selected parameters in a first sequence of bytes representing the encoded values, the physical units in which the encoded values were measured, and the times and dates of the measurement of the encoded values, the system comprising:
a plurality of remote stations, each including
a discrete data packager for inserting into the first sequence of bytes description
bytes describing a transformation of the first sequence of bytes into a second shortened sequence of bytes and a discrete transmitter for transmitting the second sequence of bytes to the bi-directional wireless digital communications system; and a user station for receiving the second sequence of bytes from the bi-directional wireless digital communications system and extracting the encoded values of the selected parameters from the second sequence of bytes.

2. The system of claim 1, wherein the data packager eliminates bytes representing decimal points, punctuation, and spaces in the first sequence of bytes.

3. The system of claim 1, wherein the description bytes include initial date bytes and interval bytes representing the date the encoded values were measured and the interval between the measurements, thereby allowing elimination from the second sequence of bytes of repetitions of bytes representing the complete date and time of measurement of each encoded value.

4. The system of claim 1, wherein the description bytes include an information byte representing the physical units in which each of the encoded values was measured.

5. The system of claim 1, wherein the data packager:
eliminates bytes representing decimal points, punctuation, and spaces in the first sequence of bytes; and
inserts description bytes that include
an initial date byte and an interval byte representing respectively the date the encoded values were measured and the interval between the measurements, thereby allowing elimination from the second sequence of bytes of repetitions of bytes representing the complete date and time of measurement of each encoded value and
an information byte representing the physical units in which the encoded values were measured, thereby allowing elimination from the second sequence of bytes of repetitions of bytes representing the physical units in which each encoded value was measured.

6. The system of claim 5, wherein the wireless digital communications system is a bi-directional pager system.

7. The monitoring system of claim 6, wherein the user station includes a communications interface for communicating control signals to the bi-directional pager system for transmission to the remote stations and each remote station includes:
a discrete receiver for receiving control signals from the bi-directional pager system; and a discrete controller for controlling transmission of the second sequence of bytes by the first transmitter.

8. A system for use in a cathodic protection system for pipeline monitoring in combination with a bi-directional wireless digital communications system for receiving signals from and transmitting signals to remote transceiver units, the system comprising:
a plurality of remote stations, each including
a monitor for measuring values of corrosion protection parameters,
an encoder for encoding the values determined by the monitoring means,
a recorder for recording data representing the encoded values,
a receiver for receiving control signals from the bi-directional wireless digital communications system,
a transmitter for transmitting the recorded data to the bi-directional wireless digital communications system, and
a controller for controlling the transmitter to transmit recorded data to the bi-directional wireless digital communications system in response to receipt by the receiver of a control signal from the bi-directional wireless digital communications system; and
a user station including
means for transmitting control signals to the bi-directional wireless digital communications system for transmission to the receivers of the remote stations, and
means for receiving from the bi-directional wireless digital communications system recorded data transmitted to the bi-directional wireless digital communications system by the transmitters of the remote stations.

9. A system for monitoring at a plurality of remote sites the values of selected parameters, the system for use with a bi-directional wireless digital communications system for receiving signals from and transmitting signals to remote transceiver units, the system comprising:
a plurality of remote stations, each including
a monitor for measuring values of the selected parameters,
an encoder for encoding the values determined by the monitoring means,
a recorder for recording data representing the encoded values,
a receiver for receiving control signals from the communications system,
a transmitter for transmitting the recorded data to the communications system, and
a controller for controlling the transmitter to transmit recorded data to the communications system in response to receipt by the receiver of a control signal from the communications system;
a stationary host station including
means for transmitting control signals to the communications system for transmission to the receivers of the remote stations, and
means for receiving from the communications system recorded data transmitted to the communications system by the transmitters of the remote stations; and
a mobile host system including a global position sensor for determining the location of the mobile host system, the mobile host system configured to
transmit control signals to the receiver of a remote station and receive recorded data transmitted from the remote station when it determines from the global position sensor that it is within range of the remote station, and
transmit recorded data received from the remote station to the communications system when it determines from the global position sensor that it is within range of the communications system.

10. A method for transmitting an original sequence of data symbols from a first location to a second location via a communications system, comprising:
at the first location, shortening the original sequence of data symbols by deleting data symbols at predetermined positions in the original sequence of data symbols so as to form a shortened sequence of data symbols;
transmitting the shortened sequence of data symbols via the communications system from the first location to the second location; and
at the second location, inserting predetermined data symbols at predetermined positions in the shortened sequence of data symbols,
whereby the original sequence of data symbols is reproduced identically at the second location.

11. The method of claim 10, wherein the communications system is a bi-directional pager system.

12. A system for transmitting an original sequence of data symbols from a first location to a second location via a communications system, comprising:
at the first location, a first processor for shortening the original sequence of data symbols by deleting data symbols at predetermined positions in the original sequence of data symbols so as to form a shortened sequence of data symbols;
a first transmitter for transmitting the shortened sequence of data symbols via the communications system from the first location to the second location; and
at the second location, a second processor for inserting predetermined data symbols at predetermined positions in the shortened sequence of data symbols,
whereby the original sequence of data symbols is reproduced identically at the second location.

13. The system of claim 12, wherein the communications system is a bi-directional pager system.

14. The system of claim 13, wherein the sequence of data symbols is a representation of a series of values of a variable quantity measured at the first location.

15. The system of claim 14, additionally comprising:
a second transmitter for transmitting control signals from the second location to the first location via the communications system; and
a controller for controlling a process at the first location in response to the control signals.

16. The system of claim 15, wherein the process is measurement of the values of the variable quantity.

17. The system of claim 15, wherein the process is transmission of the sequence of data symbols by the first transmitter.
